(19) United States
(12) Patent Application Publication
(10) Pub. No.: US 2007/0239811 A1
(43) Pub. Date: Oct. 11, 2007

(54) Multiplication by one from a set of constants using simple circuitry

(76) Inventor: Leo Bredehoft, Longmont, CO (US)

Correspondence Address: TENSORCOMM, INC., 1490 W. 121ST AVE., SUITE 202, WESTMINISTER, CO, 80234, US

(21) Appl. No.: 11/398,229

(22) Filed: Apr. 5, 2006

(51) Int. Cl. G06F 1/02; G06F 7/58

(52) U.S. Cl. 708/250

(57) ABSTRACT

A cascaded multiplier is configured for multiplying an input value by one of a predetermined set of coefficients. Each multiplier stage performs a set of elementary operations, including shifting, signal selection, addition, and subtraction. Each multiplier stage is responsive to at least one input control signal to control at least one elementary operation for selecting the coefficient. The cascaded multiplier may include a right-shift register.

### BACKGROUND

1. Field of the Invention

This invention relates to programmable logic devices configured to perform multiplication.

2. Discussion of the Related Art

Certain digital signal processing applications require multiplication of a variable by one of a set of constants. A common prior-art technique employs a full multiplier circuit with a constant read-only memory (ROM). The efficiency of this approach is impeded by the necessity for a large multiplier circuit and a large ROM.

Another prior-art technique uses a multi-constant canonic signed digit pattern search (such as described in V. Lèfevre, “Multiplication by an Integer Constant,” INRIA Report No. 4192, May 2001, Viller-Les-Nancy, France) in which a multiplier circuit simultaneously produces results for all constants and selects one of the results. This approach is inherently inefficient, since only one result needs to be produced.

Finite impulse response filters, as well as other digital signal-processing applications that perform large numbers of multiplications can benefit from a technique that improves the efficiency of multiplications.

### SUMMARY OF THE INVENTION

Embodiments of the present invention relate to computer-implemented multiplication using elementary operations, such as shifts (i.e., multiplication by a power of two), additions, and subtractions. Embodiments of the invention may provide for smaller, faster, and/or less power-consuming circuits.

In one embodiment of the invention, a sequential multiplication means is configured for performing a plurality of sequential multiplication operations. The sequential multiplication means may include, by way of example, but without limitation, a plurality of multipliers arranged to operate sequentially. Each multiplier typically comprises at least one elementary operation, such as shifting, addition, sign selection, and/or subtraction. Furthermore, each multiplier is configured to be responsive to at least one input control signal for controlling the at least one elementary operation. An input control signaling means is coupled to the sequential multiplication means to produce the at least one input control signal for each multiplier. The input control signaling means may include, by way of example, but without limitation, any signal generation circuitry or any signal selection circuitry configured to produce the at least one input control signal for selecting a predetermined coefficient to multiply an input value.

In another embodiment, the sequential multiplication means further comprises a right-shifting means configured for right shifting an output of the sequential multiplication means. The right-shifting means may include, by way of example, but without limitation, a right-shift register.

In yet another embodiment, the sequential multiplication means comprises a mapping means, such as a circuit configured to perform at least one of a set of mapping functions, including reordering coefficients and rejecting coefficients. For example, coefficients may be reordered to produce a set of ascending (or descending) coefficients, and duplicate coefficients may be removed.

Various functional elements, separately or in combination, depicted in the figures may take the form of a microprocessor, digital signal processor, application specific integrated circuit, field programmable gate array, or other logic circuitry programmed or otherwise configured to operate as described herein. Accordingly, embodiments may take the form of programmable features executed by a common processor or discrete hardware unit.

These and other embodiments of the invention are described with respect to the figures and the following description of the preferred embodiments.

### BRIEF DESCRIPTION OF THE DRAWINGS

Embodiments according to the present invention are understood with reference to schematic block diagrams of FIGS. 1, 2, 5, 6, and 7, and plots of FIGS. 3 and 4.

FIG. 1 is a block diagram of an n^{th} multiplier stage of a plurality N of cascaded multiplier stages in accordance with an embodiment of the present invention.

FIG. 2 is a block diagram of a cascade of N multiplier stages in accordance with an embodiment of the invention.

FIG. 3 is a plot showing the quantization match of coefficients related to values of sₙ and qₙ selected by an exhaustive search to have the smallest maximum error relative to a predetermined function.

FIG. 4 is a plot of coefficients as a function of a control parameter cₙ prior to deleting duplicate coefficients and reordering.

FIG. 5 is a block diagram of an n^{th} multiplier stage in accordance with an alternative embodiment of the present invention.

FIG. 6 is a block diagram of a cascade of N multiplier stages in accordance with an alternative embodiment of the invention.

FIG. 7 shows an alternative embodiment of a multiplier stage.

### DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

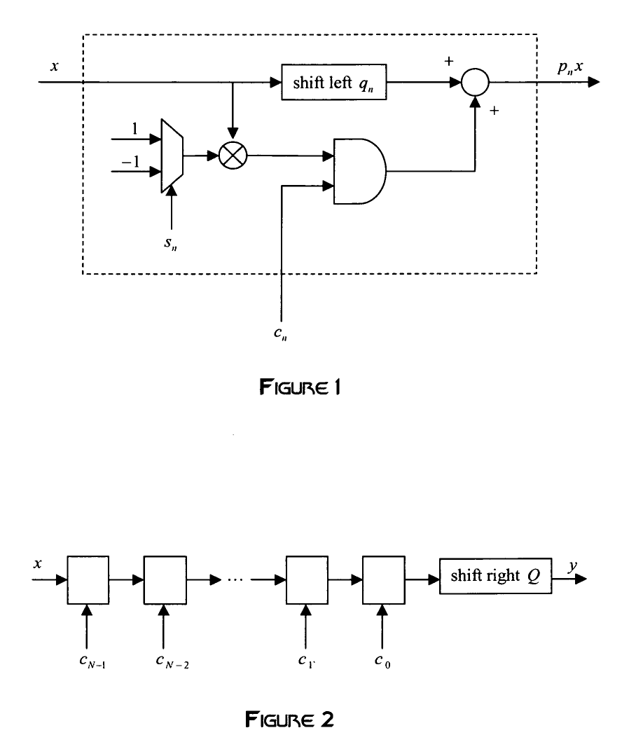

FIG. 1 is a block diagram of an n^{th} multiplier stage of a plurality N of cascaded multiplier stages in accordance with an embodiment of the present invention. The n^{th} multiplier stage is configured to multiply an input value x by one of two predetermined constants pₙ. An input signal x is processed by a left-shift register configured to effectively multiply the input signal x by 2^{q}^{ₙ}. The input signal x may also be operated upon by a sign value sₙ. An input selector value cₙ and the signed input signal are input to an AND gate. The AND gate's output is summed with the left-shift register's output by a summer (e.g., a binary adder) to produce an output pₙx.

The constant pₙ has an associated left-shift value qₙ, which represents the bit spacing for the two canonic signed digits in the constant pair associated with the n^{th} multiplier stage. The sign value sₙ sets the sign of the less significant of the two digits. An input control signal, such as the input selector value cₙ, may include a binary value that selects the constant by which the stage will multiply. The sequence of selector inputs cₙ, n=0, . . . , N−1 forms a binary number c used to select one of the constants for multiplication by the cascaded multiplier. The sign value sₙ may be hard coded or it may be an input control signal.

FIG. 2 is a block diagram of a cascade of N multiplier stages. At the output, a shift right by Q bits may be performed, such as to provide for fractional multiplication. The output of the cascaded multiplier is expressed as

$$y = ( {2}^{- Q} {\prod }_{n = o}^{N - 1} ( {2}^{{q}_{n}} + {s}_{n} {c}_{n} ) ) x$$

In one embodiment, the parameters qₙ and sₙ may be pre-set, such as predetermined by a particular hardware configuration. In this case, the input selector values cₙ select the constant used for multiplication from a set of 2^{N} constants. Values for sₙ and qₙ may be selected by employing numerical optimization or exhaustive search.

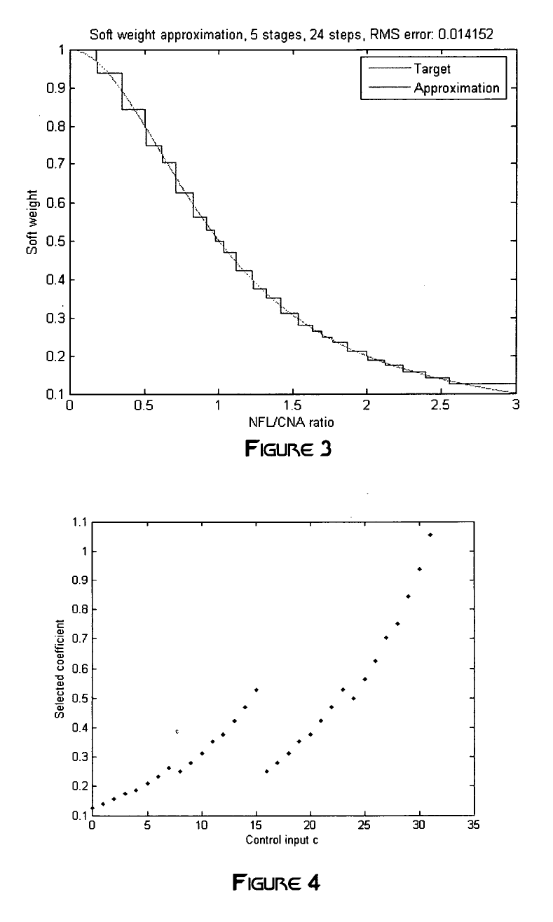

A selection algorithm can reduce some error in the coefficient set associated with sₙ and qₙ values with respect to a desired set of coefficients or coefficient span coverage. For example, FIG. 3 shows the quantization match of coefficients related to values of sₙ and qₙ selected by an exhaustive search to have the smallest maximum error relative to a predetermined function. In this exemplary case, the function (and thus, the set of coefficients) may be used to select soft weights for symbol estimates in a CDMA receiver.

FIG. 4 is a plot of coefficients as a function of control parameter cₙ prior to deleting duplicate coefficients and reordering. In this exemplary case, the multiplier had parameter values Q=9 and q=[3 2 1 0 0]. The coefficients for the cascaded multiplier are not necessarily a monotonic function of c, nor is it necessarily possible for them all to fit in the range of interest. They also may not be unique. For some embodiments, it may be advantageous to precede the c input with a mapping circuit to reorder coefficients and reject those that are not desired. If 2^{N} possible coefficients are desired, it may be necessary to use N+1 multiplier stages and reject the undesired coefficients.

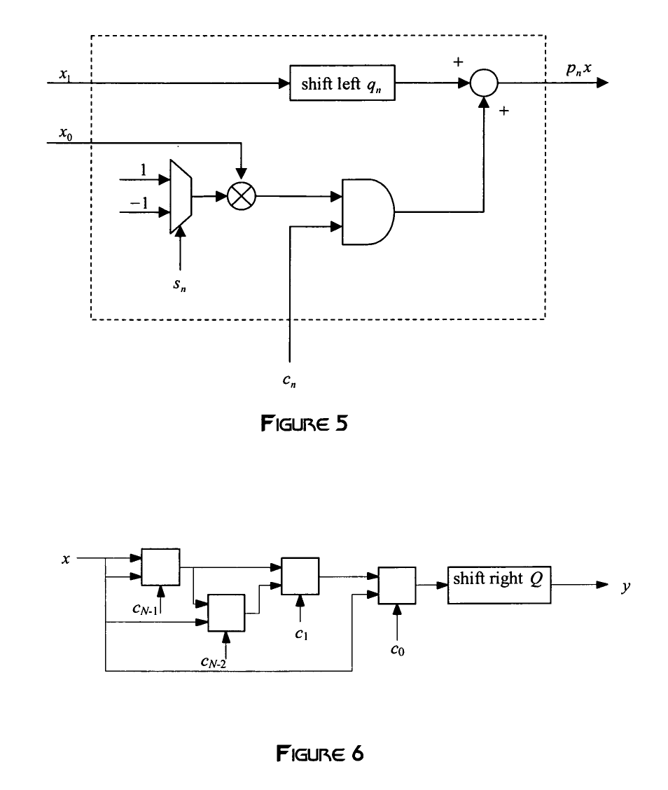

Embodiments of the invention may employ multiplier stages having alternative configurations. For example, with no increase in hardware complexity, an alternative embodiment of the invention may increase the possible number of coefficient sets for a given stage count N by splitting the input to the multiplier, such as shown in FIG. 5. These two-input stages may be connected in a feed-forward network of various topologies chosen to minimize an error criterion. One such configuration is shown in FIG. 6, which has a benefit of providing no increase in hardware complexity with respect to the embodiment shown in FIG. 2. Other benefits and advantages may be provided by the embodiments described herein and their variations.

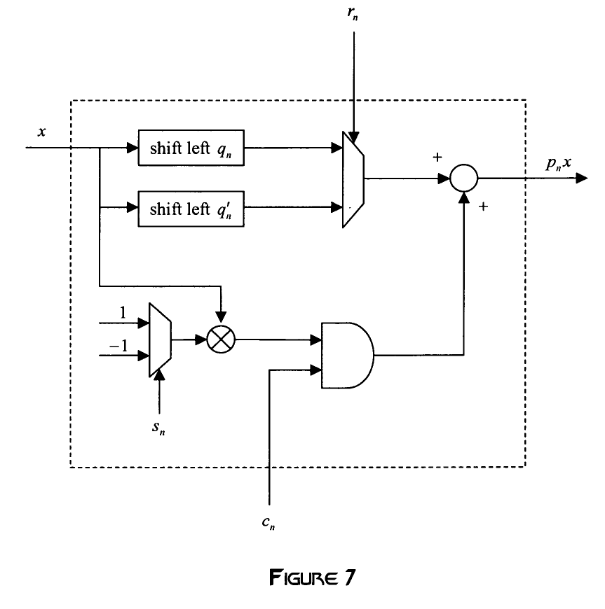

FIG. 7 shows an alternative embodiment of a multiplier stage further comprising a multiplexer in the upper path of the multiplier stage to permit dynamic selection of the left shift. This alternative embodiment balances the combinatorial delay of the AND gate with that of the multiplexer and is of minimal additional complexity. As described in previous embodiments, the sign selector sₙ may be changed from a hard parameter to a dynamic selection.

Those skilled in the art should recognize that method and apparatus embodiments described herein may be implemented in a variety of ways, including implementations in hardware, software, firmware, or various combinations thereof. Examples of such hardware may include Application Specific Integrated Circuits (ASICs), Field Programmable Gate Arrays (FPGAs), general-purpose processors, Digital Signal Processors (DSPs), and/or other circuitry.

The method and system embodiments described herein merely illustrate particular embodiments of the invention. It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as applying without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A cascaded multiplier configured for multiplying an input value by one of a predetermined set of coefficients, comprising:
a plurality of cascaded multiplier stages, each of the plurality of cascaded multiplier stages configured to be responsive to at least one input control signal to control at least one of a set of elementary operations, the set comprising shifting, addition, and subtraction.

2. The cascaded multiplier recited in claim 1, wherein the at least one input control signal is a binary value.

3. The cascaded multiplier recited in claim 1, wherein the at least one input control signal includes at least one of a sign value and an input selector value.

4. The cascaded multiplier recited in claim 1, wherein each of the plurality of cascaded multiplier stages comprises a left-shift register, a multiplier, an AND gate, and a summer.

5. The cascaded multiplier recited in claim 1, further comprising a right-shift register at the output of the plurality of cascaded multiplier stages.

6. The cascaded multiplier recited in claim 5, wherein the right-shift register outputs a signal y expressed by
$$y = ( {2}^{- Q} {\prod }_{n = o}^{N - 1} ( {2}^{{q}_{n}} + {s}_{n} {c}_{n} ) ) x ,$$
where Q is a number of bits right shifted by the right-shift register, qₙ is a number of bits left shifted by an n^{th}-stage left-shift register, sₙ is an n^{th}-stage sign value, cₙ is an n^{th}-stage input selector value, and x is the input value.

7. The cascaded multiplier recited in claim 6, wherein values of qₙ and sₙ are preset.

8. The cascaded multiplier recited in claim 7, wherein the values for sₙ and qₙ are selected using at least one of a set of selection techniques, the set comprising numerical optimization and exhaustive search.

9. The cascaded multiplier recited in claim 1, wherein the predetermined set of coefficients comprises soft weights, and the input value is a symbol estimate.

10. The cascaded multiplier recited in claim 1, further comprising a mapping circuit to perform at least one of a set of mapping functions, the set comprising reordering coefficients and rejecting coefficients.

11. The cascaded multiplier recited in claim 1, wherein each of the plurality of cascaded multiplier stages is a multiple-input multiplier stage connected in a feed-forward network of a topology chosen to minimize an error criterion.

12. The cascaded multiplier recited in claim 1, configured to operate in at least one of a set of devices, the set comprising a microprocessor, a digital signal processor, an application specific integrated circuit, and a field programmable gate array

13. A method for multiplying an input value by one of a predetermined set of coefficients, the method comprising:
providing for performing a plurality of sequential multiplication operations, wherein each of the plurality of sequential multiplication operations comprises at least one elementary operation of a set comprising shifting, addition, and subtraction, and
providing for generating at least one input control signal to control the at least one elementary operation in each of the plurality of sequential multiplication operations.

14. The method recited in claim 13, wherein the at least one input control signal is a binary value.

15. The method recited in claim 13, wherein the at least one input control signal includes at least one of a sign value and an input selector value.

16. The method recited in claim 13, wherein each of the plurality of sequential multiplication operations comprises left shifting an input signal to produce a left-shifted input signal, selecting a sign for the input signal to produce a signed input signal, providing for responsiveness to an input control signal for selecting between the signed input signal and a zero value, and summing the left-shifted input signal with one of the signed input signal and zero.

17. The method recited in claim 13, further comprising providing for right-shifting an output of the plurality of sequential multiplication operations.

18. The method recited in claim 17, wherein providing for performing a plurality of sequential multiplication operations, followed by providing for right-shifting, produces a signal y expressed by
$$y = ( {2}^{- Q} {\prod }_{n = o}^{N - 1} ( {2}^{{q}_{n}} + {s}_{n} {c}_{n} ) ) x ,$$
where Q is a number of bits right shifted, qₙ is a number of bits left shifted, sₙ is an n^{th}-stage sign value, cₙ is an n^{th}-stage input selector value, and x is the input value.

19. The method recited in claim 18, wherein values of qₙ and sₙ are preset.

20. The method recited in claim 19, wherein the values for sₙ and qₙ are selected using at least one of a set of selection techniques, the set comprising numerical optimization and exhaustive search.

21. The method recited in claim 13, wherein the predetermined set of coefficients comprises soft weights, and the input value is a symbol estimate.

22. The method recited in claim 13, further comprising at least one of providing for reordering coefficients and providing for rejecting coefficients.

23. The method recited in claim 13, wherein providing for performing a plurality of sequential multiplication operations comprises providing for a plurality of multiple-input multiplier stages connected in a feed-forward network of a topology chosen to minimize an error criterion.

24. A system configured for multiplying an input value by one of a predetermined set of coefficients, the method comprising:
a sequential multiplication means is configured for performing a plurality of sequential multiplication operations, wherein each of the plurality of sequential multiplication operations comprises at least one elementary operation of a set comprising shifting, addition, and subtraction, and
an input control signaling means configured for generating at least one input control signal to control the at least one elementary operation in each of the plurality of sequential multiplication operations.

25. The system recited in claim 24, wherein the at least one input control signal is a binary value.

26. The system recited in claim 24, wherein the at least one input control signal includes at least one of a sign value and an input selector value.

27. The system recited in claim 24, wherein the sequential multiplication means is configured for left shifting an input signal to produce a left-shifted input signal, selecting a sign for the input signal to produce a signed input signal, providing for responsiveness to an input control signal for selecting between the signed input signal and a zero value, and summing the left-shifted input signal with one of the signed input signal and zero.

28. The system recited in claim 24, wherein the sequential multiplication means further comprises a right-shifting means configured for right shifting an output of the sequential multiplication means.

29. The system recited in claim 28, wherein the sequential multiplication means and the right-shifting means are configured to produce an output signal y expressed by
$$y = ( {2}^{- Q} {\prod }_{n = o}^{N - 1} ( {2}^{{q}_{n}} + {s}_{n} {c}_{n} ) ) x ,$$
where Q is a number of bits right shifted, qₙ is a number of bits left shifted, sₙ is an n^{th}-stage sign value, cₙ is an n^{th}-stage input selector value, and x is the input value.

30. The system recited in claim 29, wherein values of qₙ and sₙ are preset.

31. The system recited in claim 30, wherein the values for sₙ and qₙ are selected using at least one of a set of selection techniques, the set comprising numerical optimization and exhaustive search.

32. The system recited in claim 24, wherein the predetermined set of coefficients comprises soft weights, and the input value is a symbol estimate.

33. The system recited in claim 24, further comprising a mapping means configured for performing at least one of a set of mapping functions, including reordering coefficients and providing for rejecting coefficients.

34. The system recited in claim 24, wherein the sequential multiplication means comprises a plurality of multiple-input multiplier stages connected in a feed-forward network of a topology chosen to minimize an error criterion.
